(19) United States
(12) Patent Application Publication
(10) Pub. No.: US 2019/0155971 A1
(43) Pub. Date: May 23, 2019

(54) DEVICE DISLOCATION STRESS SIMULATION

(71) Applicant: Samsung Electronics Co., Ltd., Suwon-si (KR)

(72) Inventors: Chihak Ahn, Fremont, CA (US); Woosung Choi, Pleasanton, CA (US)

(21) Appl. No.: 15/875,916

(22) Filed: Jan. 19, 2018

Related U.S. Application Data
(60) Provisional application No. 62/588,875, filed on Nov. 20, 2017.

(51) Int. Cl. G06F 17/50

(52) U.S. Cl. CPC G06F 17/5009; G06F 2217/16; G06F 17/5018

(57) ABSTRACT

A system and method for calculating stress in a device includes receiving an analytic solution domain and calculating initial analytic values for displacement and stress for a dislocation in the domain and creating a stress profile using the initial displacement and the initial stress as initial values of a stress equilibration equation.

### CROSS-REFERENCE TO RELATED APPLICATION(S)

The present application claims priority to, and the benefit of, U.S. Provisional Patent Application No. 62/588,875, filed on Nov. 20, 2017, the contents of which are incorporated herein by reference in its entirety.

### BACKGROUND

### 1. Field

Some embodiments of the present disclosure relate generally to semiconductor process modeling.

### 2. Description of the Related Art

The semiconductor fabrication process may produce large amounts of stress on the devices being produced. In some instances, the stress may cause defects to be introduced into the crystalline structure of the device. These defects may lead to dislocations that may result in device failure. In other cases, producing dislocations may be desirable for a device's design. In either case, creating a stress profile for predicting dislocations is needed.

There are several conventional methods that have been used to simulate a stress profile of a device. The Eigenstrain (slab insertion) method is able to produce reasonable stress simulation results, however, requires a large amount of manual work by a user to achieve good results. A non-local model is not as accurate as the Eigenstrain method, but requires less manual work. The image method also has a relatively low amount of manual work required, however, the method is only applicable to limited cases and requires extra calculation steps. Thus, a new methodology for simulating a stress profile is desired.

The above information is only for enhancement of understanding of the background of embodiments of the present disclosure, and therefore may contain information that does not form the prior art.

### SUMMARY

Some embodiments of the present disclosure provide a system and method for device stress simulation.

According to some embodiments, a stress simulation system may include a memory and a processor. In various embodiments, the processor is configured to execute instructions from the memory that, when executed by the processor, cause the processor to calculate an initial analytic solution for an initial displacement (u0) and an initial stress (ρ0) in an analytic solution domain and simulate a stress profile for an extended domain using the initial displacement and the initial stress as initial values of a stress equilibration equation.

According to some embodiments, the analytic solution domain includes at least one dislocation.

According to some embodiments, the analytic solution domain has an infinite medium.

According to some embodiments, the stress equilibration equation is a finite element method stress equilibration equation.

According to some embodiments, the stress equilibration equation defined by ∫σδ(Bu)dV=0.

According to some embodiments, the stress equilibration equation is a finite volume method stress equilibration equation.

According to some embodiments, the at least one dislocation is a curved dislocation and the initial analytic solution is calculated for the curved dislocation.

According to some embodiments the at least one dislocation is a screw dislocation and the initial analytic solution is calculated for a screw dislocation.

According to some embodiments, the at least one dislocation is an edge dislocation and the initial analytic solution is calculated for the edge dislocation.

According to some embodiments, the instructions further cause the processor to calculate a second initial analytic solution for a second initial displacement (u0) and a second initial stress (σ0) in a second analytic solution domain and simulate a second stress profile for a second extended domain using the second initial displacement and the second initial stress as initial values of the stress equilibration equation, and generate a superposed stress profile by superposing the second stress profile on the stress profile.

According to some embodiments, the stress equilibration equation has a continuous displacement condition for a dislocation at the analytic solution domain (e.g. the extended domain boundary).

According to some embodiments, the analytic solution domain is smaller than the extended domain.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments can be understood in more detail from the following description taken in conjunction with the accompanying drawings, in which:

FIG. 1 depicts a method for simulating dislocation stress according to various embodiments;

FIG. 2 includes depicts an example analytic solution domain in accordance with various embodiments;

FIG. 3 includes generalized equations for stress (a) and displacement (u)

FIG. 4A depict the initial analytic solutions for the simulation of two dislocations in silicon according to various embodiments;

FIG. 4B depicts the final FEM solutions for the simulation of two dislocations in silicon using the initial analytic solutions of FIG. 4A according to various embodiments;

FIG. 5 depicts an example of superposition of dislocations according to various embodiments;

FIG. 6 depicts a method of superposing simulations according to various embodiments;

FIG. 7 depicts example results from performing the method of FIG. 6 according to various embodiments;

FIG. 8A is a block diagram of a computing device according to an embodiment of the present invention;

FIG. 8B is a block diagram of a computing device according to an embodiment of the present invention;

FIG. 8C is a block diagram of a computing device according to an embodiment of the present invention;

FIG. 8D is a block diagram of a computing device according to an embodiment of the present invention; and

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In various embodiments, a system and method for device stress simulation is configured for simulating stress profiles of semiconductor devices by utilizing analytic solutions as initial values for a stress equilibration equation. The system utilizes a computing device to calculate the analytic solutions for dislocations. In various embodiments, the system may utilize the calculated analytic solutions as the initial values for performing Finite Element Method (FEM) or Finite Volume Method (FVM) stress simulations. Accordingly, the system can accurately simulate stress for all types of dislocations and allows for the superposition of multiple dislocations.

In various embodiments, a device has one or more elements to be simulated to create a stress profile. For each individual element being simulated, the system has a net force of zero since all of the elements are static (e.g. not in motion). For example, a master equation (e.g. a virtual work formulation) shown in Equation 1 may be used to describe the stress for each element:

∫σδ(Bu)dV=0 Equation 1

where:

σ=DB(u−u₀)+σ′+σ₀ Equation 2

or

σ=D(Bu−ε₀)+σ°+σ₀ Equation 3

In various embodiments, σ is used to describe the stress on the system and u₀ describes the displacement. σ* may denoted all other unrelaxed stress sources (e.g. thermal stress, lattice mismatch stress. D is the elastic stiffness tensor (e.g. a spring constant in 1 dimension) and B is a differential operator applied to displacement to generate strain (e.g. the relative change from the equilibrium lattice constant).

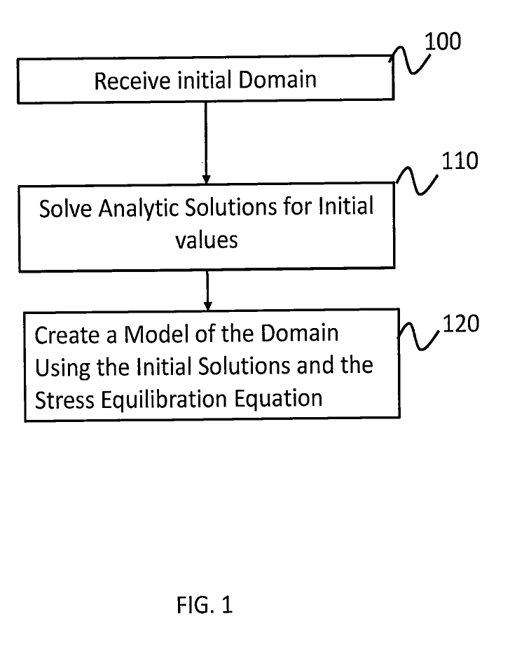

FIG. 1 depicts a method for simulating dislocation stress according to various embodiments.

Referring to FIG. 1, in various embodiments, a domain is selected for performing the initial stress simulation (S100). In various embodiments, the domain (e.g. an analytic solution domain) is a finite device region that is a relatively smaller subsection of a larger FEM domain. In various embodiments, a domain may be selected to include at least one dislocation or other source of force (e.g. stress) and any missing or additional planes. The defined domain may also have any shape that encloses the defined dislocations and stacking fault regions and the final results may not be initial domain dependent.

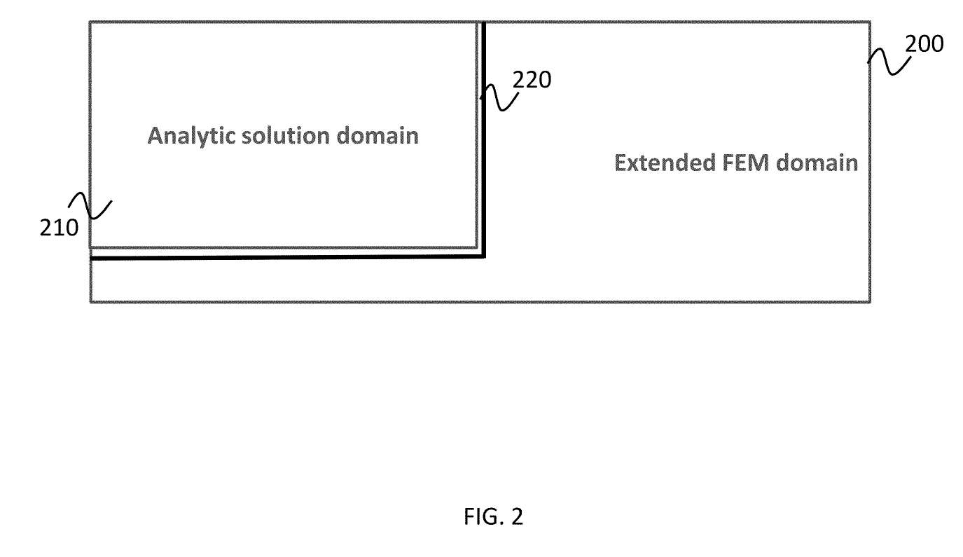

FIG. 2 includes depicts an example analytic solution domain in accordance with various embodiments.

Referring to FIG. 2, an extended FEM domain 200 and an analytic solution domain 210 are depicted. In various embodiments, the FEM domain 200 may include one or more regions in a device being simulated. In various embodiments, the analytic solution domain 210 that is selected may have a rectangular shape that is relatively smaller than the extended FEM domain 200. When the selected analytic solution domain 210 is relatively small compared to the FEM domain 200, a boundary region 220 may be present. At the boundary region, displacement continuation should be enforced to equilibrate stress in the whole system. Other boundary conditions, such as the continuation of the change of displacement, may be used to preserve stress history. For example, when a new simulated region is deposited on top of the originally simulated regions, the newly deposited region is stress free and stress at the boundary region 220 should discontinue into the new region.

Referring back to FIG. 1, simulation of stress profile for the domain is initiated by calculating an initial analytic solution (S110). In some embodiments, the initial analytic solutions includes a pair (u₀, σ₀) that is representative of the initial displacement and stress of the system (displacement, stress) in an infinite medium. In some embodiments, the initial pair (ϵ₀, σ₀) may be used instead of (u₀, σ₀) where ϵ₀=Bu₀.

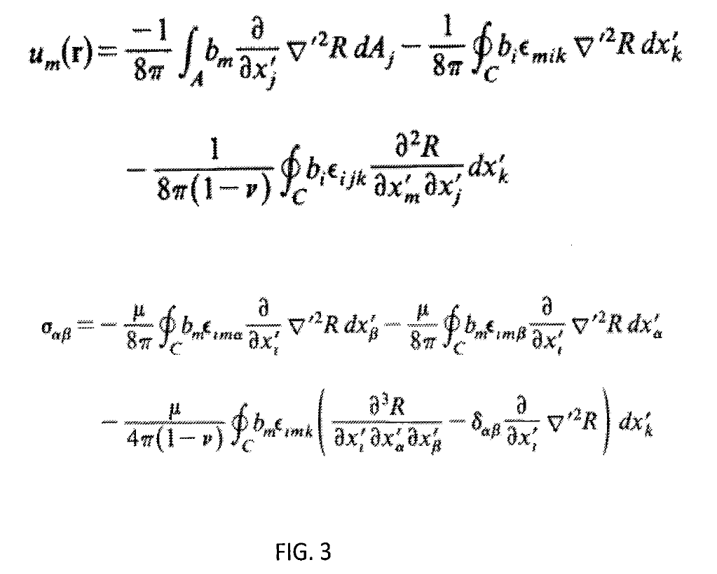

FIG. 3 includes generalized equations for stress (a) and displacement (u).

Referring to FIG. 3, the system may be utilized to simulate any type of dislocation by utilizing the generalized equations to solve for the initial analytic solution. For example, the generalized equations may be used to solve for curved dislocations and linear dislocations. These equations may be simplified for solving for particular types of dislocations. For example, in various embodiments, the initial analytic solution may be calculated by solving a closed form analytic equation for a line dislocation. For example, when simulating a screw dislocation, the closed form equation for a screw dislocation may be described by Equations 4-6.

$$\begin{matrix}{u}_{z} = \frac{{b}_{s} ( θ + α )}{2 π} & Equation 4 \\ {σ}_{xz } = - \frac{{Gb}_{s}}{2 π} \frac{y}{{x}^{2} + {y}^{2}} & Equation 5 \\ {σ}_{yz} = - \frac{{Gb}_{s}}{2 π} \frac{x}{{x}^{2} + {y}^{2}} & Equation 6\end{matrix}$$

In another example, the closed form equation for an edge dislocation may be described by Equations 7-13.

$$\begin{matrix}{u}_{x} = \frac{{b}_{e}}{2 π} ( θ + α + \frac{1}{2 ( 1 - v )} \frac{xy}{{x}^{2} + {y}^{2}} ) & Equation 7 \\ {u}_{y} = - \frac{{b}_{e}}{8 π ( 1 - v )} ( ( 1 - 2 v ) log ( {x}^{2} + {y}^{2} ) + \frac{{x}^{2} - {y}^{2}}{{x}^{2} + {y}^{2}} ) & Equation 8 \\ {σ}_{xx} = - Dy \frac{3 {x}^{2} + {y}^{2}}{{( {x}^{2} + {y}^{2} )}^{2}} & Equation 9 \\ {σ}_{yy} = Dy \frac{{x}^{2} - {y}^{2}}{{( {x}^{2} + {y}^{2} )}^{2}} & Equation 10 \\ {σ}_{xy} = Dx \frac{{x}^{2} - {y}^{2}}{{( {x}^{2} + {y}^{2} )}^{2}} & Equation 11 \\ {σ}_{zz} = v ( {σ}_{xx} + {σ}_{yy} ) & Equation 12 \\ {D}_{ } = - \frac{{GB}_{e}}{2 π ( 1 - v )} & Equation 13\end{matrix}$$

In various embodiments, a dislocation may be a hybrid of various types of dislocations. For example, a dislocation may be a hybrid edge/screw dislocation. In another example, the dislocation may be a hybrid curved/linear dislocation. In these examples, the generalized equations for stress (σ) and displacement (u) may be used.

In various embodiments, after solving for the initial analytic solutions, the master equation (equation 1) may be evaluated for the complete FEM/FVM domain (S120) to generate a stress profile. The results may then be plotted and provided to the user.

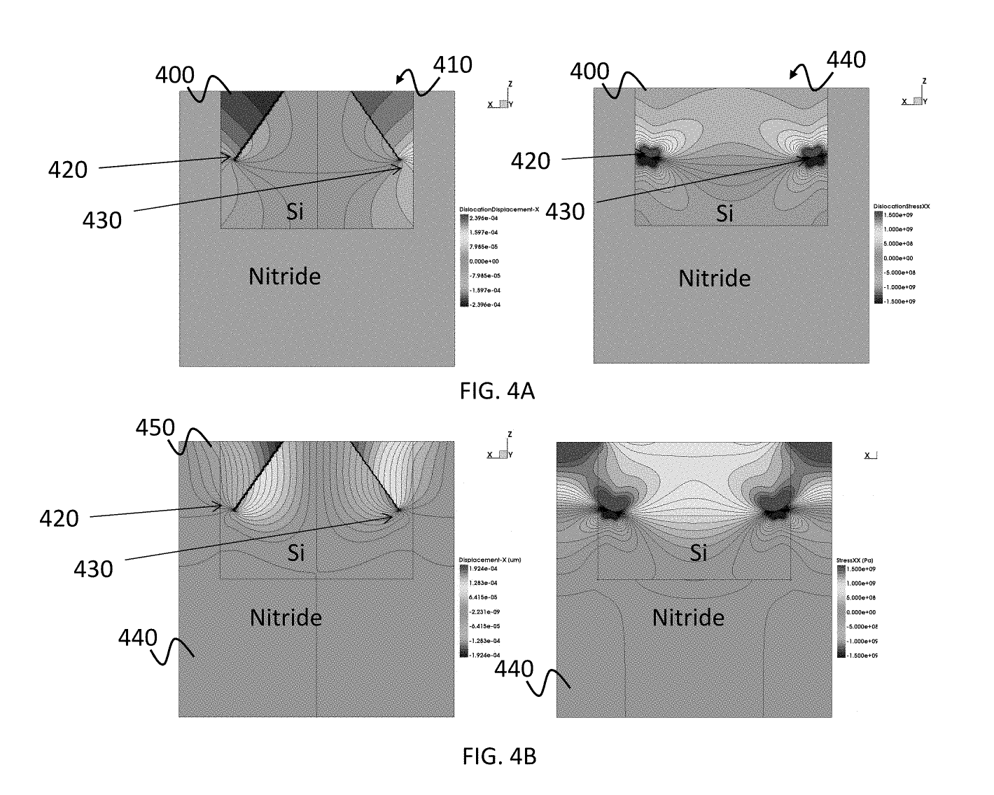

FIGS. 4A and 4B depict an example simulation of two dislocations in silicon according to various embodiments. FIG. 4A depicts initial analytic solutions and FIG. 4B depicts the final FEM Solutions.

Referring to FIG. 4A, in various embodiments, a user defines an analytic domain 400 that encompasses a first dislocation 420 and a second dislocation 430 to be simulated. In this embodiment, the initial analytic domain 400 includes a silicon region. The initial analytic solutions include a displacement (u) solution 410 and a stress (a) solution 440. Referring to FIG. 4B, in various embodiments, the system may utilize the analytic solutions of FIG. 4A to solve for the final FEM solution. In this example, the system solved for the complete domain 440, including the nitride region. The example also includes a continuation of the displacement of the dislocations passed the original domain boundary into the simulated region 450.

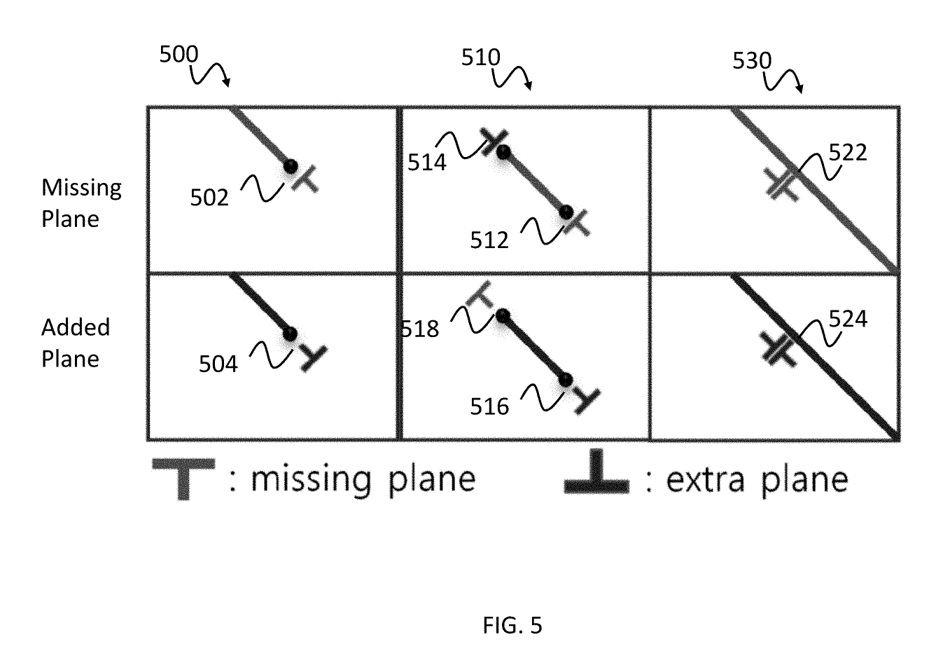

In various embodiments, the system may be utilized for superimposing multiple dislocations or defects. For example, FIG. 5 depicts an example of superposition of dislocations according to various embodiments.

Referring to FIG. 5, in various embodiments, the dislocation stress simulator may be utilized to superimpose any number of dislocations. FIG. 5 includes three examples 500, 510, 520 where the top row of each example includes a missing plane-type and the bottom row includes an added plane-type. The top row of the first example 500 includes a missing plane-type dislocation 502 located in the bulk of the device that goes from the dislocation 502 to the surface. The bottom row of the first example 500 includes an added plane-type dislocation 504 that goes from the dislocation 504 to the surface. The second example 510 shows how a missing plane-type dislocation 512 may have an extra plane 514 added near the surface to simulate a terminated missing plane inside the domain. Similarly, the extra plane-type 516 may be terminated by the missing plane-type 518. The third example 520 depicts the simulation of a completely missing plane (522) without dislocation cores by combining two missing plane-type dislocations (e.g. the missing plane-type dislocations 502) in opposite directions. Similarly, the bottom row depicts the simulation of a complete extra plane through the domain without any dislocation cores by combining two extra plane type dislocations (e.g. the extra plane-type dislocations 504) in opposite directions.

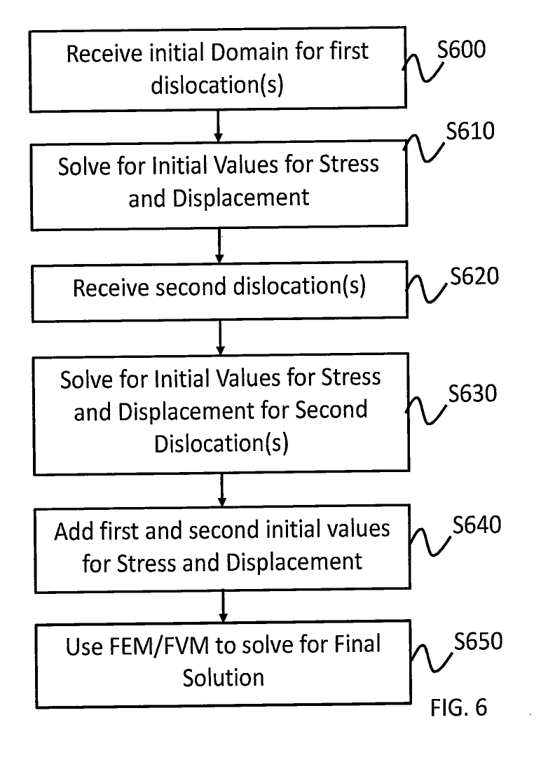

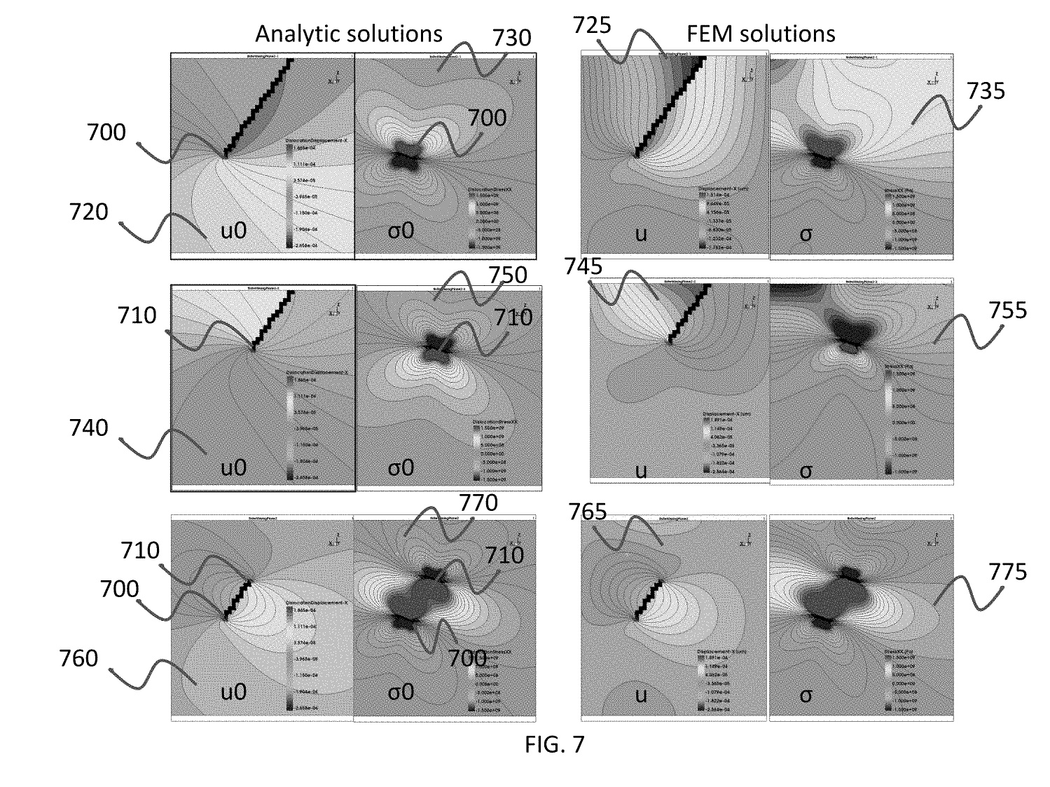

FIG. 6 depicts a method of superposing simulations according to various embodiments. FIG. 7 depicts example results from performing the method.

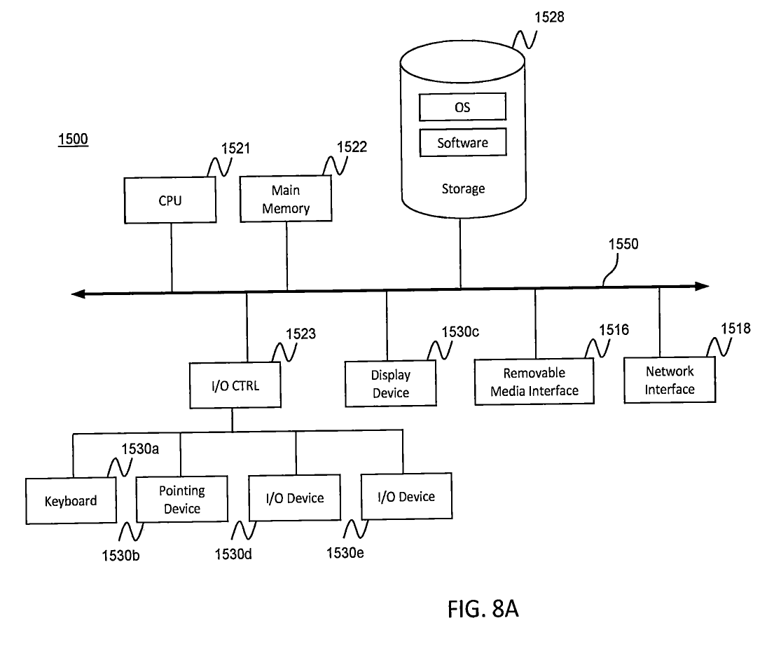

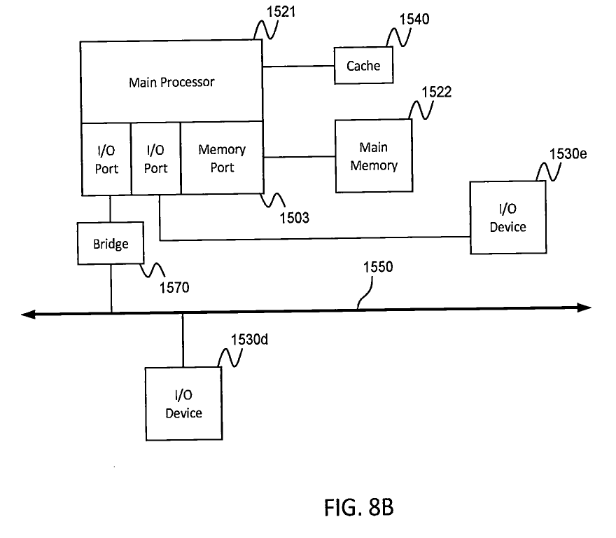

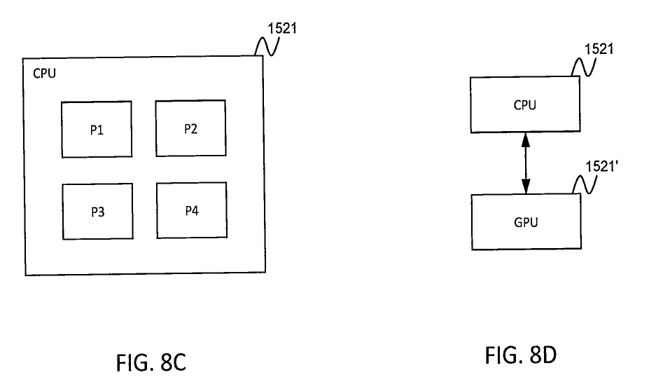

Referring to FIGS. 6 and 7, in various embodiments a user may wish to simulate superposing dislocations. In various embodiments, a user may supply a first dislocation 700 (or multiple dislocations) in a first domain (S600). The initial analytic solutions for displacement (u) 720 and stress (σ) 730 may then be solved for (S610). In various embodiments, the user may elect to find the final FEM or FVM solution for displacement (u) 725 and stress (σ) 735 for the dislocation. In other embodiments, the user may elect to skip simulating the defect and move on to the adding a superposed dislocation. In various embodiments, the user provides a second dislocation 710 (or group of dislocations) for superposing on the first dislocation(s) (S620). In various embodiments, the second dislocation(s) 710 may be in the same domain as the first dislocation 700. The initial analytic solutions for displacement (u) 740 and stress (a) 750 may then be solved for the second dislocation(s) 710 (S630). Again, the user may elect to find the final FEM or FVM solution for displacement (u) 745 and stress (σ) 755 for the second dislocations, but in other examples the user may not. The initial analytic solutions for displacement (u) 720, 740 and stress (σ) 730, 750 may then be added to solve for a superposed initial analytic solutions for displacement (u) 760 and stress (σ) 770 (S640). The final FEM or FVM solution for displacement (u) 765 and stress (σ) 775 may then be solved for (S650). FIG. 8A and FIG. 8B depict block diagrams of a computing device 1500 as may be employed in the device stress simulation system according to some example embodiments. Each computing device 1500 may include a central processing unit 1521 and a main memory unit 1522. As shown in FIG. 8A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 8B, each computing device 1500 may also include various additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 8A, the central processing unit 1521 communicates with the main memory 1522 via a system bus 1550. As shown in FIG. 8B, the central processing unit 1521 may also communicate directly with the main memory 1522 via a memory port 1503.

FIG. 8B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 8A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 8B depicts an embodiment of a computer 1500 in which the central processing unit 1521 communicates directly with I/O device 1530e. FIG. 8B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 8A, may control the I/O devices. The I/O controller may control one or more I/O devices such as a keyboard 1530a and a pointing device 1530b, e.g., a mouse or optical pen.

Referring again to FIG. 8A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 8A and FIG. 8B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

As shown in FIG. 8C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 8D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

Accordingly, the above described embodiments of the present disclosure provide a semiconductor device stress simulation system.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A stress simulation system comprising:
a memory; and
a processor, wherein the processor is configured to execute instructions from the memory that, when executed by the processor, cause the processor to:
calculate an initial analytic solution for an initial displacement (u₀) and an initial stress (σ₀) in an analytic solution domain; and
simulate a stress profile for an extended domain using the initial displacement and the initial stress as initial values of a stress equilibration equation.

2. The system of claim 1, wherein the analytic solution domain includes at least one dislocation.

3. The system of claim 2, wherein the at least one dislocation comprises a curved dislocation and the initial analytic solution is calculated for the curved dislocation.

4. The system of claim 2, wherein the at least one dislocation comprises a screw dislocation and the initial analytic solution is calculated for the screw dislocation.

5. The system of claim 1, wherein the at least one dislocation comprises an edge dislocation, and the initial analytic solution is calculated for the edge dislocation.

6. The system of claim 1, wherein the at least one dislocation comprises a hybrid dislocation, and the initial analytic solution is calculated for the hybrid dislocation.

7. The system of claim 1, wherein the analytic solution domain comprises an infinite medium.

8. The system of claim 1, wherein the stress equilibration equation comprises a finite element method stress equilibration equation.

9. The system of claim 8, wherein the stress equilibration equation defined by ∫σδ(Bu)dV=0.

10. The system of claim 1, wherein the stress equilibration equation comprises a finite volume method stress equilibration equation.

11. The system of claim 1, wherein the instructions further cause the processor to:
calculate a second initial analytic solution for a second initial displacement (u0) and a second initial stress (σ0) in a second analytic solution domain; and
simulate a second stress profile for a second extended domain using the second initial displacement and the second initial stress as initial values of the stress equilibration equation; and
generate a superposed stress profile by superposing the second stress profile on the stress profile.

12. The system of claim 1, wherein the stress equilibration equation has a continuous displacement condition for a dislocation.

13. The system of claim 1, wherein the analytic solution domain is smaller than the extended domain.

14. A method of calculating stress in a device, the method comprising:
receiving, by a processor, an analytic solution domain;
calculating, by the processor, an initial analytic solution for an initial displacement (u0) and an initial stress (σ0) in the analytic solution domain;
creating a stress profile, by the processor, for an extended domain using the initial analytic values as an initial value of a Finite Element Method stress equilibration equation.

15. The method of claim 14, wherein the analytic solution domain includes at least one dislocation.

16. The method of claim 14, wherein the analytic solution domain comprises an infinite medium.

17. The method of claim 14, wherein the stress equilibration equation comprises a finite element method stress equilibration equation.

18. The method of claim 17, wherein the finite element method stress equilibration equation is ∫σδ(Bu)dV=0.

19. The method of claim 14, wherein the stress equilibration equation comprises a finite volume method stress equilibration equation.

20. The method of claim 14, wherein the initial analytic solution is calculated for a curved dislocation.

21. The method of claim 14, wherein the initial analytic solution is calculated for a screw dislocation.

22. The method of claim 14, wherein the initial analytic solution is calculated for an edge dislocation.

23. The method of claim 14, further comprising:
calculating, by the processor, a second initial analytic solution for a second initial displacement (u0) and a second initial stress (σ0) in a second analytic solution domain; and
simulating, by the processor, a second stress profile for a second extended domain using the second initial displacement and the second initial stress as initial values of the Finite Element Method stress equilibration equation; and
generating, by the processor, a superposed stress profile by superposing the second stress profile on the stress profile.

24. The method of claim 14, wherein the stress equilibration equation has a continuous displacement condition for a dislocation.

25. The method of claim 14, wherein the analytic solution domain is smaller than the extended domain.

26. A method of calculating stress in a device, the method comprising:
receiving, by a processor, an analytic solution domain containing at least one dislocation;
calculating, by the processor, an initial analytic solution for an initial displacement (u0) and an initial stress (σ0) in the analytic solution domain;
creating a stress profile, by the processor, for an extended domain using the initial analytic values as an initial value of a Finite Element Method stress equilibration equation.
